(19) United States
(12) Patent Application Publication
(10) Pub. No.: US 2025/0156974 A1
(43) Pub. Date: May 15, 2025

(54) MARKET SYSTEM ENABLING THE SALE, SHARING, DISTRIBUTION, PROMOTION AND MARKETING OF WORKS WITH NFT AND TIMESTAMP IN DIGITAL ENVIRONMENT AND METAVERSE

(71) Applicant: Sinan Sahbudak, Istanbul (TR)

(72) Inventor: Sinan Sahbudak, Istanbul (TR)

(21) Appl. No.: 18/835,681

(22) PCT Filed: May 9, 2023
(86) PCT No.: PCT/TR2023/050426

§ 371 Date: Aug. 2, 2024

(30) Foreign Application Priority Data
Jan. 4, 2023 (TR) 2023/000126

(51) Int. Cl. G06Q 50/18

(52) U.S. Cl. CPC G06Q 50/184

(57) ABSTRACT

A system for publishing various digital and printed works using Qualified Intellectual Property (QIP) and timestamping in a digital environment supported by artificial intelligence. The system operates on blockchain technology, utilizing smart contracts and NFTs for distribution, promotion, and sales. The system functions on multiple blockchains or through interchain passages. The system includes services for detecting and addressing copyright infringements using algorithms. The system incorporates features for environmental conservation, tracking contributions to nature preservation with each transaction through blockchain registration. The system includes the distribution of tokens to authors and related parties based on readership or work creation. The system extends to metaverse applications for promotion, marketing, and sales of works. The system provides a comprehensive, secure, and environmentally conscious platform for digital publishing and content management.

### TECHNICAL FIELD

This invention is related to the publishing of the works (all kinds and types of digital or printed, audio books, scientific articles or papers, scripts, articles, peer-reviewed publications, magazines and journals of every kind, etc.), by means of Qualified Intellectual Property (QIP) and time stamp, by the author or title holder publishing house, uniquely in digital environment in the form of both first production and second-hand product and in any language whatsoever with the support of artificial intelligence, either by creating its own network or for running in polygon network or other networks (these networks indeed vary depending upon the licensing processes in blockchain and the working dynamics of each network, but polygon is only one of them and is exemplary), through working in more than one blockchain or via interchain passages, and with the support of smart contracts developed by Ethereum network (stands for internodal links and passages and for links in nodes), in line with the blockchain technology, as well as the duplication, promotion, distribution and sales services thereof, and again on NFT base, the promotion, marketing, distribution and sales of the works in metaverse (digital universe), and the detection and follow-up of infringements on copyrights with the help of algorithms, and the provision of such services to the author/publishing house in this aspect as well, and in these sales and/or promotion and marketing activities, for the sake of preservation of forest areas and nature with each transaction, and for follow-up of trees grown and contributions made to the nature, and for transparency therein, through registration of the same on blockchain, and timing thereof, and follow-up of its unchangeable and approved structure and process, and the distribution of token gifts again to authors or related interests through the market, and the distribution of various token as it is read or as the works are created.

### BACKGROUND ART

2.1. As the name suggests, printed publications are produced, distributed, marketed and sold in publishing houses by physical printing. Likewise, articles are also published on various platforms through various internet service providers.

2.2. Again, with the exception of printed publications, any work belonging to the author is taken under protection by means of registration and protection processes through notaries or registration/copyright institutions for a certain period of time and solely within the borders of a certain geographical area.

2.3. Again, the copying and pirated sale of all kinds of works have become untraceable for this reason, thereby leading to unregistered earnings to the detriment of authors and other related right holders.

2.4. Author, publisher or right holder cannot generate income from the second-hand sale of the work. In this sense, the second-hand sales of these works remain unrecorded and untraceable for author and/or right holder.

2.5. Due to high costs of printed publications, neither author nor processor of a translation text with a prior license received from author can financially afford to publish his work, or market the resulting product, and most importantly, the costs double until the work reaches readers, and it becomes impossible to trace and determine the real value of the work.

2.6. Although the exercise of certain rights and authorizations by publishing houses on behalf of author (academician, researcher, screenwriter, educator, poet, article writer-BRIEFLY AUTHOR) (likewise the protection of certain rights by publishing houses) is a facilitating process for author, it causes an increase in costs in the processes that bring author and reader together.
Production (harmful impact due to the sourcing of t raw materials generally from nature—e.g. paper)
Labor force (how many people work for this business?)
Transportation (Labor-fuel-consumption-cost-time-waste)
Sales (factors affecting the cost reach the reader at an unnecessarily high cost and profit margin)

Taken together, all of them result not only in unnecessary costs, but also in great damage to nature. On the other hand, a number of unnecessary transactions increasing the costs take place between author on one side and the party accessing the work on the other side.

2.7. Publishers or various internet service providers or websites and/or applications are not able to track the processes of plagiarism, pirated sale, and unauthorized copying of the work.

2.8. Especially today and in the developing technological process, securing and tracking the work (periodicals, non-periodicals, books, etc.) will and have already become very easy with the digital coding and encryption method, thus gaining an ongoing and growing momentum. The relief of author from the monopoly of publishing house will also make it much easier for the work to reach readers.

2.9. NFT (QIP) is the English abbreviation for non-fungible token, also translated into Turkish as “Qualified Intellectual Property”. The English equivalent thereof is “non-fungible token”. NFT is a unit of data that certifies the uniqueness of any digital file in digital ledger on the blockchain. It is essentially known as a digital collection developed as a result of smart contract provided by Ethereum chain. It can be created and reproduced in different chains and sold in NFT markets. So far, however, NFTs have only been created, reproduced and sold in the form of collections. It is a virtually-augmented reality file that contains the unique encoding of token ID and contract address, i.e. digital address code and a combination of this address. NFT is not processable as a substitute, nor can it be altered or tampered with. NFTs are formed when cryptographic hash sequence records, a set of characters that verify the uniqueness of a data set, are strung onto previous records, thus creating a chain of identifiable data blocks. This cryptographic transaction process authenticates each digital file by providing a digital signature that is used to track NFT ownership. Author can convert it to NFT as many times as he wishes.

2.10. Again, in the current situation, where holder of NFT and author are not the same person, the determination of who the right holder is, in fact who the author is, is still an issue to be overcome. This issue can be resolved in the pre-NFT process with a timestamp/digital signature and the work can be converted into an NFT. This is not currently in practice. This can be secured in advance with a timestamp.

The main elements of blockchain are security, decentralization, privacy and transparency. This is achieved in different ways. Proof Of Work and Proof Of Stake have been developed in its working logic. Proof Of Work works with the logic of compromise and mining. Each piece of data that wants to be included in blockchain network needs to be approved by the entire network, resulting in a mining service where this approval process is carried out every 10 minutes and blocks are formed, in return for which a reward mechanism is operated. Proof Of Stake is intended to provide and increase the chance of reward as much as the amount pledged by the networks included in the system rather than mining services. In the first case, Proof Of Work was disadvantageous in terms of speed and energy, so Proof Of Stake was developed in 2012. Then scalability came into play this time. Network interoperability and transitions are also processes that are currently being evaluated and developed.

An alternative to the exemplary chains is the POLYGON blockchain. This is because polygon minimizes scaling, speed and costs by using side-chains (rollups), i.e. by running off-chain and running the data later with plasma security and Proof Of Stake, ensuring that data is included in the network periodically. Moreover, it seems to be the most suitable chain to run for NFT platform with polygon or different chain alternatives. In summary, some transactions are made outside (outside the blockchain) and are summarized (in the sidechain) in a certain cryptographic order and then added to the main chain, which greatly reduces traffic and GAS costs.

Moreover, the mentioned DAPP (blockchain application) is not produced on NFT platform-market. In this respect, as stated, it is incomplete.

2.12. Now, let's look at what kind of a world the current web 2.0 and web 3.0, which we are preparing to transition to and even starting to transition to, offer us: In summary, Web 2.0, as it is known, is the embodiment of centralized structures on the internet. By going beyond the limited network of Web 1.0, we can talk about a structure that became valid with the spread of internet all over the world. Web 3.0, on the other hand, is a structure based on decentralization, where nodes are involved in the whole process, where fair participation can be ensured through transparent, consensus/agreement protocols. In any case, the internet is user-friendly. With Web 2.0, we have witnessed and are witnessing that Facebook, Google, Amazon, etc. generate revenue from user data and that this is not shared fairly with any user, or even not shared at all. Already web 3.0 is turning this on its head, creating innovation and devastating impact that enables also all participants to monetize their own data in particular. In this sense, present invention is relevant to the process and the technology that gives rise to the innovation.

2.13. Metaverse is a parallel digital universe connected to our physical world through multiple digital technologies. So it's actually virtual reality or augmented reality. Avatars (characters), which are determined by users in the physical world, perform many operations and vital virtual activities in Metaverse universe (virtual universe), which emerged with NFT and grew in importance and was designed entirely as an NFT, as if they were in the physical world. I think this basic information on this subject will be sufficient, as it has an equivalent in terminology and there are many sources.

Currently, there has not been and is not currently any distribution, marketing and promotion of NFTs that are the subject of the invention in any metevarse universe anywhere in the world. Thanks to Metaverse, it is possible to create virtual stands and display products thereon. With augmented reality, it is also possible for authors to exhibit their works in this universe.

Currently, such a practice has not taken place to date. Although some brands such as NIKE etc. are promoted and sold in metaverse universe in various ways, and stores are created in this way, no platform connected with the market, also connected with the works of the invention, has been so far realized in the metaverse. Details can be found in the invention description.

2.14. Again, in the current situation; in both physical and virtual environments; no social responsibility that would be subject to invention for climate peace, nature protection, the existence of a green world and the breathing of the world has been fulfilled, and no blockchain application has operated this facility between chains. The invention description explains how it works in an integrated manner.

The general working logic of the blockchain is as follows: I encrypt an asset that has been sent to me in a timely manner via a public key, using my private key, and send it to someone else. The system checks these processes every 10 minutes and grinds them into a package. Using encryption, I transfer a digital asset that I have proved to be mine to someone else with certainty through hashing (grinder). And I don't need anyone's approval for that. This is not just for a digital currency. It applies to all digital assets and is very convenient and secure.

Blockchain is the general name for a chain of consecutive blocks, consisting of sequential blocks in a timeline that includes the date and time information of the data in a sequential manner, where the first block is named Genesis. Each block carries digital signature of the block that precedes it, thus ensuring correlation/consensus. This consensus can be achieved publicly, with data distributed in a publicly visible way.

### DESCRIPTION OF THE INVENTION

IN SUMMARY, IN THE DIGITAL WORK PRODUCED WITH NFT:
You are the digital producer of the work you are the author of. You have all the codes and passwords!
You, as the author, determine how much the work costs and how much it should be sold to the reader!
It is possible to reach anywhere in the world in 1 second! Increasing your recognition as a writer is entirely within your competence. It is possible to grow in line with your success! Moreover, as the author, you directly have all rights and obligations on your own! And you determine your profit. You can determine how many pieces you will produce and the profit that will remain for you (the author) when the person who buys it from you sells it on second-hand to a third party.
You are in a world at peace with nature. There are no printed documents, no works, no publications. When needed, whomsoever needs can print it out
Moreover, you deliver your work to the consumer, to the curious, to those who want to learn in a few seconds.
There is only one labor force in this world. And that is you, the author-writer. Only 1 person.
You actually secure your copyright, publishing rights, ownership of works with digital codes, hashes and incredible passwords in the blockchain. An indelible, indestructible assurance. You can reach it at any point where the cable reaches. All data is indelibly everywhere. The rights and obligations belong to you as the author. When you plagiarize or are exposed to plagiarism in the work, you are directly and actively in the middle of the process with all the means of proof and everything can be proven. There is no escape from claiming rights and paying people their due. The more transparent you become, the richer you become materially and spiritually.
Marketing becomes equivalent to your name and your work. If you allocate some of the money you pay to big publishing houses and cut your profits to your advertising, you can be sure that it will be easier for you to reach everyone and you cannot believe that your quality works will spread very fast. As it spreads, as it passes from hand to hand, you keep winning. Even a book sold in a digital bookstore will be profitable.
In the Metaverse universe, the user is ensured to create his own digital work stand. This is committed. He will do the marketing himself. The user will make their own works. The invention opens up space. A digital marketplace is opened up for the user. NFT PUBLISHING HOUSE! ON TOP OF THAT, A PROCESS THAT WILL TURN THE NATURE-FRIENDLY CHANGE AND TRANSFORMATION OF THE CLIMATE IN FAVOR OF HUMAN BEINGS

The aim of the invention includes the publishing of the works (all kinds and types of digital or printed, audio books, scientific articles or papers, scripts, articles, peer-reviewed publications, magazines and journals of every kind, etc.), by means of Qualified Intellectual Property (QIP) and time stamp, by the author or title holder publishing house, uniquely in digital environment with the support of artificial intelligence, either by creating its own network or for running in polygon network or other networks, through working in more than one blockchain or via interchain passages, and with the support of smart contracts developed by Ethereum network (stands for internodal links and passages and for links in nodes), in line with the blockchain technology, as well as the duplication, promotion, distribution and sales services thereof, and again on NFT base, the promotion, marketing, distribution and sales of the works in metaverse (digital universe), and the detection and follow-up of infringements on copyrights with the help of algorithms, and the provision of such services to the author/publishing house in this aspect as well, and in these sales and/or promotion and marketing activities, for the sake of preservation of forest areas and nature with each transaction, and for follow-up of trees grown and contributions made to the nature, and for transparency therein, through registration of the same on blockchain, and timing thereof, and follow-up of its unchangeable and approved structure and process, and the distribution of token gifts again to authors or related interests through the market, and the distribution of various token as it is read or as the works are created.

First of all, after the ownership and time of the work (any type of book, article, script, prescription, etc.) is secured with a timestamp, it is converted to NFT. Subsequently, the above-mentioned procedures for the registration of the above-mentioned work and the determination and securing of its ownership are also intended to provide the possibility of international registration in the virtual environment with the technological flow explained above and exemplified below, to the extent it complies with the legislation of the country which governs it and by following the legal changes or amendments (obligations such as banderrol etc., rights currently granted to publishing houses and compliance with the copyright obligations of the country where it is located and organized as NFT PUBLICATIONS). Here novelty is the following: first of all, it is aimed to bring together the writer (author and/or creator) and the reader in a metaverse world in a digital/virtual environment.

In terms of the NFT, as already mentioned above, only NFT works bought and sold by collectors are available on various platforms (e.g. NFT markets such as OPENSEA, RARIBLE, etc.). However, none of these and similar ones are related to the creation, sale, distribution, copying, second-hand sale of all kinds of digital or printed, audio books, scientific articles, scripts, articles, peer-reviewed publications, all kinds of magazines, journals, etc. as NFT, but only provide services for various digital collections. Currently, no NFT market in the world provides the sale or distribution of printed, audio books, scientific articles, scripts, articles, peer-reviewed publications, all kinds of magazines, journals, etc. by creating the NFT on the same platform (market). On the other hand, the said transaction will be digitally proven with a timestamp. Again, various algorithms will be used to track the traces of unauthorized copy on nodes. This is because the blockchain contains immutable and indelible data and allows accessibility in any situation.

### BRIEF DESCRIPTION OF THE FIGURES

The invention will now be described by referring to the attached figures, whereby the features of the invention will be understood more clearly. However, it is not intended to limit the invention to these particular embodiments. On the contrary, it is aimed to involve all alternatives, modifications, and equivalents without departing from the scope of the present invention as defined in the attached claims. It should be noted that the details shown herein are only for illustrating the preferred embodiments of the present invention, and for providing the most useful and clear description of both the illustration of methods, and the principles and conceptual features of the present invention. In these drawings,

FIG. 1—A detailed view of the production, distribution, marketing and sales stages of a work without the use of blockchain technology in a physical or virtual environment.

FIG. 2 Detailed information on creating NFTs with smart contracts, offering NFTs for sale in the created marketplace, bringing the author and the interested parties together without the need for a direct intermediary, and the sale of works.

FIG. 3 A small and very expressive visual representation of a decentralized structure where there is no need for any intermediary.

FIG. 4 Simple representation of the NFT creation processes.

FIG. 5 An illustration of a blockchain while creating an NFT.

FIG. 6 Schematic view of the Polygon Chain.

### REFERENCE NUMERALS

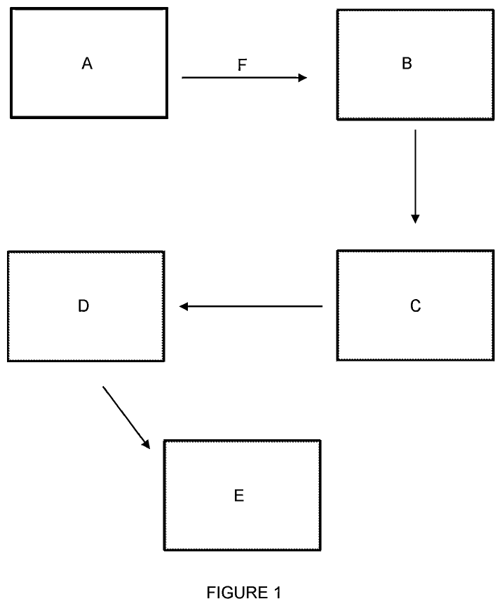

### FIG. 1:

A: Work of the author,
B: Publishers or Websites,
C: Preparation of the work for printing, typesetting, etc.
D: Publication of the Work,
E: ISBN—ISSN Number Identification from the Ministry of Culture and Tourism, General Directorate of Libraries and Publications,

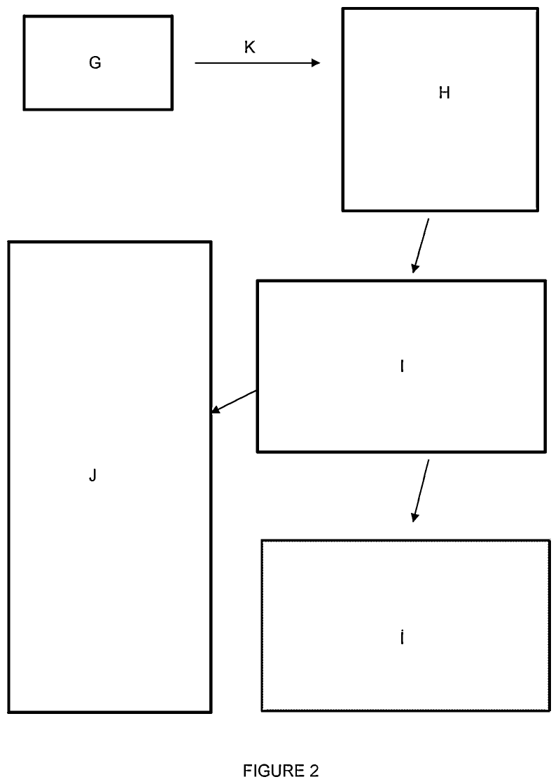

### FIG. 2:

G: Work of the Author,
H: Conversion of the Work into an NFT by the Author, whose ownership has been previously approved and established, after determining the number of copies of the Work and the amount of profit to be made from second-hand circulation,
I: Creation of a Work NFT Number, Tracking Pirate NFT Tracking Processes with Algorithm, Tracking Unauthorized Reproduced Publications with Artificial Intelligence Supported Software and Detection of Block Chain's Unalterable and Indelible Technology (Distributed Ledger),
i: The Author will also be able to sell it through auction or for a fixed amount through Etherium, different tokens, self-created tokens. Before the amount is transferred, there will be a tax deduction at the source, which will vary depending on the functioning of the relevant State.
J: Establishing Blogs, Forums and Correspondence Routes between the Author and the Reader, Establishing an Ecosystem to Support the Entrepreneurship Pool, Ensuring the Development of the System with Open Source Codes. Establishing a Decentralized Structure, Contributing to the Development of the System for Creating a Market, Dissemination of WEB 3.0 Technology and Creation of an Ecosystem, Extension of the Ecosystem for the Protection of Nature through an Integrated Structure or Agreements by the Author and/or the Market. In Turkey, it is possible to sign an agreement with TEMA Foundation and contribute to nature in every transaction.
K: Time Stamp

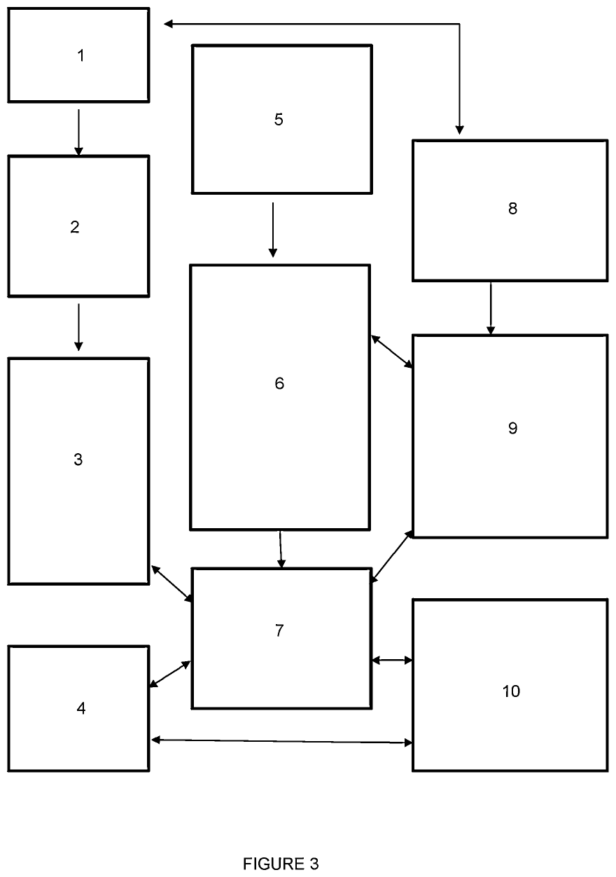

### FIG. 3:

1. Authors and Publishers, and Other Persons Wishing to Produce Digital Evidence with Time Stamps,

2. With the artificial intelligence developer, the publisher/writer/author can market books, view book sales rates, make cost-profit analysis,

3. Artificial Intelligence/AI: With the help of a software or computer program with a learning mechanism, facilitating the processes of the author and/or users as a result of motivation, experience-algorithmic learning, making the process easier, developing options according to user habits. Tracking pirated works, tracking unauthorized works on the blockchain with an algorithmic system,

4. Token: Providing rewards in stages to those who buy, read and publish works, in short, to users, paying exchange fees with the accumulated rewards, and covering the costs of creating NFTs,

5. Works are uploaded to our decentralized storage by the author/publishing house. Data kept in a secure environment can also be exported. It can also be edited by the publisher or the writer.

6. NFT: Any kind of work can be converted into NFT by the author/publisher in our market. Here, at the same time, both the timestamp processes and the registration of authorship are processed in the system with smart contracts. The NFT ID number defined for each work is unique. During the NFT conversion process, the amount of profit that the author wishes to obtain for second-hand sales can also be determined by the author.

7. STORE/MARKET: The NFT created in our market will be available in the market/store as a limited version. It will be listed for sale. The reader will also be able to access the works in audio format. So he will be able to listen it as an audio book.

8. EXCHANGE-SALE PROCESSES: It will be possible to purchase the NFT work created by the author/publishing house and to sell the purchased work to someone else on second hand.

9. SECOND HAND SALES: The person who purchases the work will also earn income when second-hand sales of the work take place in accordance with the smart contract rules determined by the author, i.e. second-hand sales profit rules.

10. SOCIAL RESPONSIBILITY: In order to contribute to nature by the publisher or user of the NFT work created in our market, or by the system/market, blockchain will also be a guide for contribution by operating or creating a harmonized blockchain process or transitioning between different chains, and confirming the physical follow-up of forestation and contribution to nature.

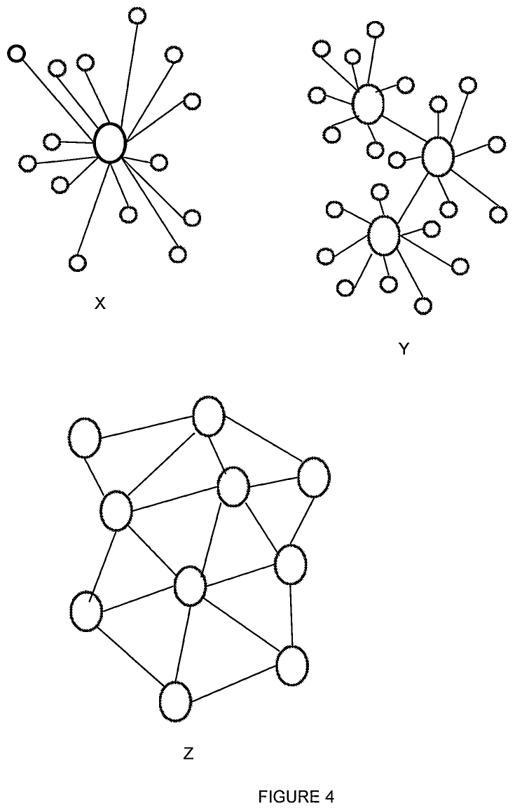

### FIG. 4:

X: Centralized, user-data center,
Y: Decentralized, user-data center,
Z: Distributed, user-data center.

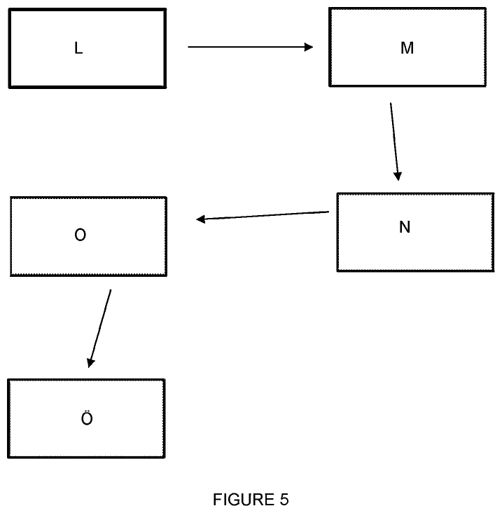

### FIG. 5—HOW TO CREATE NFT?

L: Author creates NFT.
M: Select the blockchain where the NFT will be generated. It is also created in the marketplace—the market.
N: NFT is offered for sale in the marketplace-market.
O: The NFT who pays the price in accordance with the Seller's Offer becomes the new owner of the work.
Ö: The NFT's fee is transferred to the wallet of the seller author.

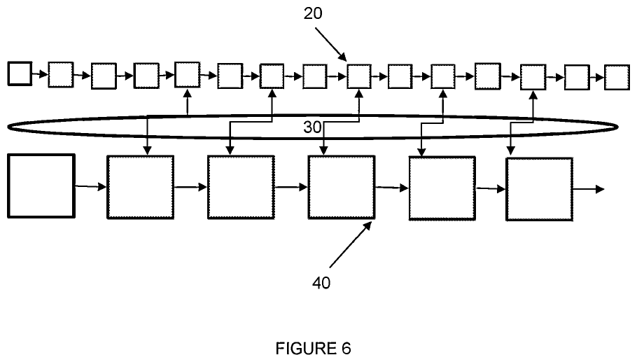

### FIG. 6:

20: Polygon Chain
30: The Bridge for Token Transfer
40: Ethereum Main Chain

3.1. As can be seen in FIG. 1, detailed description of the stages of production, distribution, marketing and sales of a work without using blockchain technology in a physical or virtual environment is provided. As explained above and as can be seen, it goes through many rather laborious stages. The meeting between author and reader requires many intermediaries. This situation also causes many unnecessary costs. Although briefly summarized in the figure, there are too many unnecessary procedures as described in point 2.6. Although the aforementioned situation eliminates some costs in the internet environment, blockchain cannot provide auditability, immutable structure and control in the absence of technological infrastructure.

3.2. FIG. 2 provides detailed information on the blockchain we explained above (after the announcement of the Bitcoin directive by Satoshi Nakamoto, the introduction of smart contracts by Ethereum founder Vitalik Buterin, the emergence of NFT with the developing and developed technology and ultimately the formation of the Metaverse), the creation of NFT with smart contracts, the sale of NFT in the created marketplace-market, the direct meeting of the author and the interested parties without the need for an intermediary (the most important innovation of Web 3.0) and the sale of the works. In addition, it is possible to contribute to the forest or water resources managed in the blockchain with organizations such as TEMA, etc. in order to protect nature and ensure climate peace. Ownership and transaction confirmations can be provided very easily. As a result of every transaction that takes place as a result of certain commands with a smart contract, every entity that contributes to nature and is beneficial to the public and humanity can be integrated into this system. It is easy to maintain control and follow the outcome. It is possible to operate a very transparent process, just like knowing and following the process from the production stage of a milk coming to the market shelves to the transportation stage thereof to the market shelves minute by minute, or being able to instantly track the funds or transactions for which a customer's time/debit deposits in a bank account is used by the bank.

3.3. FIG. 3 actually tells us a great deal. It is possible to see the transformation of the digital world summarized here. Of course, decentralized structures did not emerge with Satoshi Nakamoto. Nick Szabo is one of the pioneers of this. It would be wrong to say that Satoshi Nakamoto (someone/some group or anonymous is not yet clear) was not influenced by Nick Szabo. A small and very expressive visual representation of a decentralized structure where there is no need for any intermediary is provided. The importance of data, security, compromise, Byzantine fault tolerance can all be seen in this small way. Again, this figure illustrates transparency, that data is personalized, and that its security and privacy is actually ensured through distributed ledgers and nodes. In this way, we can see a very simplified version of technological transformation and its destructive impact.

3.4. FIG. 4 shows simple representation of the NFT creation processes. What the NFT is, how it functions, what technology it is a product of, and its systematic process of working have been explained in detail above. With regards to NFT to be created by the author in the market, the sale, marketing and how the author will be paid for the work is very briefly explained (it is worth mentioning again that there is currently no such market for works such as printed books, magazines, periodicals, scientific articles, scripts, poems, etc. anywhere in the world) (format can be in pdf etc. formats. Details of which will be explained in the invention description).

3.5—In FIG. 5, a blockchain is illustrated while creating an NFT. In the polygon network, the polygon running on the ethereum sidechain is run off-chain without being included in the network for a certain period of time. In this terminology, “sidechain”, i.e. a rollup is called a sidechain operation. There is no single Rollup technology for Ethereum, but many Rollup technologies are being developed. This ensures that the network is fast, secure and scalable. Speed, safety and low cost of GAS are interpreted as a user-friendly outcome. The low cost of NFT creation and transfer is also a convenience for the author. These costs vary depending on the size of the NFT. For example, the cost of NFT conversion and storage of a 1000-page work will be quite different. It also has a big impact on duration and speed.

Blockchain technology, as the name suggests, is based on the principle that blocks are strung together like a string to form a chain, and the information in this chain can be downloaded and stored, and the blocks to be added to the chain are decided by anyone in the world.

Blocks store the transfer data. New transfers are written in new blocks. This is where the issue of transaction fees comes from.

Each block has a capacity. In Bitcoin, blocks are 1 MB in size (we will continue with the 1 MB example, although 2 MB blocks can be produced with the SegWit softfork), and the average number of transfers that 1 MB of data can carry is 3,000. Since each block takes 10 minutes:
3,000 transfers per block/10 minutes block time=Number of transactions in 300 minutes

If 300 transactions are made in 1 minute, the formula 300/60=5 is the number of transactions per second.

If Bitcoin were to issue 1 GB blocks every second, all the Bitcoin blockchain record keepers per second in the world would not be able to keep up with the speed (too many HardDisks or SSDs would be needed to store all the data, or high-speed internet to download every block before time runs out) and the data would become out of sync, resulting in the blockchain to fail.

Therefore, we can't make the blocks too fast, as well as we can't make them too big. Our processing capacity remains at a certain limit.

Every transaction you make on Ethereum has a GAS fee. For example:
Send ETH: 21,000 GAS
Send USDT: 46, 100 GAS (Varies for each ERC20. For example, for DAI it is 35,000 GAS).
Swapping coins in Uniswap v3: 130,000 GAS
Adding Liquidity in Uniswap v3: 450,000 GAS

As you can see, the fee for each transaction is different in Ethereum. This is because not only BTC is sent on the network such as Bitcoin. The more complex the process becomes, the more space you take up in the block.

And miners will charge you more to take up space in the Ethereum block. Contrary to popular belief, ETH is very cheap to send. However, adding Liquidity on Uniswap and borrowing DAI on Compound Finance is extremely complex, takes up much more space on the block, and is therefore EXPENSIVE.

The way to reduce these costs and increase speed is through side chain rollup. Polygon is just one example of this system. Different improvements are also available. However, given the capacity of the NFT, the study should be carried out in this way.

### DETAILED DESCRIPTION OF THE INVENTION

4.1. Above, we have summarized the current situation of what blockchain, ETHEREUM, Smart Contracts, Metaverse and NFT are and what they serve and what kind of technology they contain.

4.2. Some observations were also made about the creation, publication and marketing of works on certain platforms (NFT marketplaces/markets). When we look at these platforms (RARIBLE, OPENSEA are the most well-known NFT marketplaces), all kinds of digital or printed, audio books, scientific articles, scripts, articles, peer-reviewed publications, all kinds of magazines, journals, etc. are not created, only works that are collections and created with some digital codes and/or a certain algorithm are/were created and are/were marketed as collections. The aforementioned works do not provide the service of our invention in any case and in any example.

4.3. The work we will create in our market will actually be internationally registered with the time stamp following its creation. To clarify, even if the registration is not made by the official authorities for the purpose of copyright, it will be valid in terms of proof and timing of ownership. In fact, it will be treated as a kind of international notary registration process. By making this timestamp on the blockchain, an indelible, unalterable proof of the work or proof of ownership will be created that will be valid anywhere in the world. Blockchain works as a distributed ledger or network. Unlike centralized networks (as in web 1.0-web 2.0), it has defined a decentralized structure and model. In fact, the working logic of this structure was summarized in 2009 by Satoshi Nakamoto in his article P2P: peer-to-peer transfer. While this explains the digital currency era, it also explains the decentralized, consensus protocols that are in place in almost every sector due to the smart contracts developed with Ethereum, where all networks are distributed (these are nodes with processors of all kinds. What can it be: phones, tablets, computers, smart machines, interestingly even a refrigerator in the kitchen.

These nodes operate a approval mechanism in the way the blockchain works for each block added to the network. With this approval mechanism, the security and confirmation of the data is also ensured. It makes it almost impossible to hack from the outside. Because each block is made up of this distributed data. This data is hidden by a hashing process. It is summarized by the Merkle tree. Since an attack on any part of this network or blocks will change the algorithm and operation in all blocks, the unauthorized intervention approval mechanism will be disabled as it will not operate and approval will not be given. In fact, it can also be considered as Byzantine fault tolerance in terminology.

So, in summary, the following can be stated for this part: Considering that the data (data-information) to be included in the blockchain system is transferred to very different and decentralized nodes, where it is encrypted with private and public keys, it is no longer possible to change it. The great thing about the blockchain is that every transaction since the genesis block can be accessed and tracked.

4.4. As such, it will be possible to provide security and traceability in terms of the work to be created, to determine ownership, and to prevent unfair interference. Most importantly, it will eliminate many bureaucratic procedures and minimize costs.

4.5. The positive aspects of the system have been explained in detail above. However, HOW WE CREATE NFT MARKETPLACE:
First of all, we choose the appropriate chain (blockchain) when developing NFT marketplace. However, since the developments on this chain are open source, as in many other chains, the codes are usually embedded in libraries on REMIX or GITHUB. We develop these codes for example with Visual Studio Code. It is possible to develop and build on this with other examples.
We define a wallet in the system to enable transactions in the market (for buying-selling-creating-read-monitoring). (METAMESK, TRUST, etc.) It is possible to store all kinds of crypto assets in these wallets. Moreover, the creation of these wallets is necessary and mandatory for the collection of GAS costs. These GAS payments are mandatory for the transaction to proceed. This is how the system runs. However, some explanations have been made above to minimize these costs and speed up the process. Selecting or creating the appropriate chain is important in this sense.
While creating the system, we define “Smart Contracts” for the system at every stage. We are actually embedding run commands in the system. Thanks to smart contracts, this leads us to the result as each stage is completed with commands whose process flows are defined from the beginning. The rules for this have been set from the outset and precisely. A fraudulent transaction would not be possible as the system would not work in this sense.
What NFT is and its logic was explained in detail above. My aim here is to register the ownership of all kinds of works (books, articles, poems, scripts, videos, musical works, magazines, etc.) and to deliver the work of the right holder to the buyer with very small commission fees without the need for any other intermediary. At the same time, it will also be tracked in the block chain with very small fees to be paid by author and the addressee, and thus, the contribution to nature will be beneficial in terms of increasing the forests, increasing the green area and protecting nature. So how will this be possible in this system? To explain: blockchain technology is now poised for a different transformation thanks to open source codes and developers. It will be easier for blockchains, i.e. different DAPPs, to correlate and work together. This means that multiple blockchain networks will be able to run together. From this point of view; the contribution of the work created in the market I will create to nature by the buyer and seller at a nominal cost will be able to run in an integrated manner with the chains created with this social responsibility. It is possible to establish a protocol with the TEMA foundation as an example. With the smart contract protocols and commands determined in advance, this process will be provided in the wallet-wallet part. In fact, we can conclude that pages of physical books, magazines, etc. will become disappeared with this system worldwide, they will be found in the digital environment in a copyrighted way, and reader and seller will obtain a positive result as a right holder in this sense. As mentioned above, it will also be possible to operate and run the system on blockchains, which are cheap and secure to minimize GAS costs.
There are many ways to trace the printing and distribution of pirated publications. However, it is not universally successful. It should be explained as follows: following the physical printing of the work or its publication on the internet, it is not possible to establish that the work has been copied or reproduced without authorization. Or it is not possible for author/publisher to trace the physical edition. In any case, publishing houses do not give this assurance to the author.

BUT IN NFT MARKET THE SITUATION IS SLIGHTLY DIFFERENT AND CLOSE TO PERFECT:
In our NFT MARKET, the NFT work created by author without the need for any intermediary will be registered on the blockchain. Moreover, the author will continue to earn income from the second-hand sales of the NFT and as many copies as he wishes. In other words, when the person who bought the work in the NFT market sells it to another person, the author will continue to participate in the profit of this work and earn income with the percentages to be determined by author. Each time a purchaser resells the work, the original author will continue to earn. This will increase the incentive to produce work and ensure that labor is fully compensated.
Since the works will be exhibited and published in a digital environment, the author will be able to sell his work on his own page in our market at a nominal cost without going door-to-door to publishing houses. The cost will be only his intellectual labor. Today, the royalties paid to the author are deplorable (10%-20% is paid to the author) when we look at the publishing agreements between publishing houses and author. On the other hand, the author decides how much the publication will be reproduced. The publishing house decides how many editions it will make. This is not fair at all. On the other hand, it can be said that this is the biggest obstacle to producing work.
It will be coded to the market and it will be determined whether the work has been copied or used without authorization with algorithmic data or by being able to track the transactions on etherscan from the very beginning. In other words, it will be tracked who is using the work or digital evidence without authorization and from which accounts. This also means that it acts as an international notary public, making it much easier for the relevant administrative authority in terms of means of proof and eliminating the stationery needs in the functioning of the system.
As mentioned above, the author will continue to earn income from the sale of the work at each stage (second hand, third hand, fourth hand, etc.).
Piracy will be prevented as tracking is possible.
There will be no need for pirated works as the costs of publishing will be minimized. It will be more costly for the pirate producer. This would automatically end piracy due to the unprofitable transaction.
For example, let's assume that an average book today is 500.00 TL, for example an academic book. For a student who wants to buy it, this is a considerable cost. This cost includes the cost of paper, transportation, labor, rent, all kinds of expenses, etc. However, with NFT MARKET, all these costs will be eliminated. Only nominal participation fees will be paid. Assuming that the NFT holder can produce as many works as they wish, the cost will remain the same. Therefore, it will be possible to sell this 500.00 TL book for 100.00 TL or even 10.00 TL. It's very stimulating. It is an outcome that will end piracy by itself. It is a result that will greatly satisfy the author and those interested.
As mentioned, it is quite easy to follow the footprints of the work after the first phase (i.e. after the NFT is formed). Because in the blockchain, everything is securely recorded. It is therefore quite easy to identify ownership and encroachment by the non-owner.
The format of the created NFT work will be suitable for printing and reading in any format such as pdf, jpeg, png, etc.

4.6. After the NFT work is offered for sale by the author, it is also possible for the author to interact directly with the buyer and for the author and the addressee to come together on the NFT MARKET platform. Mutual discussion on the work, exchange of ideas will be possible on Discord etc. platforms. By creating a community, information sharing and level discussions will become more enjoyable. On the other hand, each author will be able to expand the areas of effectiveness and efficiency on their NFT page.

4.7. The work can also be marketed and shared on METAVERSE. It is explained as follows:

After the work is created in the NFT MARKET, the promotion of the relevant work at the work stand to be created in the virtual world integrated with METAVERSE or at a fair organization, even the creation of signing and interview days in this METAVERSE universe, and the realization of community activities in this universe will also yield very positive results. Moreover, renting a stand in the virtual universe at the aforementioned fair (which will provide a market) will cost considerably less than in the physical world. In fact, the application of these virtual fairs to every line of business will have a very cost-reducing effect. The only handicap here is the development of user habits. This will be achieved over time.

It will also be possible for the work to be written in several languages depending on the author and to be created as an NFT. This will be possible with the language translation and enhancement option in the NFT MARKET. For example, selling a work written in Turkish by translating it into different languages in the market with the help of artificial intelligence will be an option offered to the author.

In the METAVERSE universe (virtual world-augmented reality), considering that it is formed entirely with NFT logic as a combination and that the codes are determined by this chain model, the visual presentation of the works will be very enjoyable and will yield awareness-raising results.

### 5—INDUSTRIAL APPLICATION OF THE INVENTION

The author has the sole say in the production and sale of the work and in determining its price. It participates in the market by paying small commission fees.
The author as writer determine how much the work costs and how much it should be sold to the reader!
It is possible to reach anywhere in the world in 1 second. It is entirely within the author's competence to increase his recognition as a writer. Moreover, all rights and obligations will directly belong to author. Knowing this responsibility, the author will act more diligently and carefully. It will avoid plagiarism or other offenses because every transaction is recorded.
The author can determine how many copies he will produce and the profit that will remain (to the author) when the person who buys it from him sells it second-hand to a third party.
In a world at peace with nature, there are no printed documents, works, publications. When needed, whomsoever needs can print it out. This not only reduces the costs of the relevant state, but also contributes to nature through an integrated blockchain development model (the forest contribution integration described above).
Moreover, it becomes possible to deliver the work to the consumer, to the curious, to those who want to learn, anywhere in the world in a few seconds.
You actually secure your copyright, publishing rights, ownership of works with digital codes, hashes and incredible passwords in the blockchain. It is an indelible, indestructible assurance. You can reach it at any point where the cable reaches. All data is indelibly present everywhere. The rights and obligations belong to the author. When plagiarism is present in the work or the work is exposed to plagiarism, the author is directly and actively involved in the process and is the one to deal with all means of proof, and everything can be proved.
When the author allocates some of the money that he pays to publishing houses and cuts from his profits to his advertisement, it will be easier for him to reach everyone and even the profit of his book sold in the DIGITAL SHOP will enter his pocket (profit to be earned in second-hand sales).
In the Metaverse universe, it becomes possible to create your own digital work stand and interact with the community.
This transformation will eliminate all physical printed articles and books that circulate precariously on the internet.
At the same time, digital proof and ownership registration processes will be operated for all kinds of documents.
Since there will be no physical document or paper (in correct terms, since the purchaser can print it out), costs and unnecessary waste will be avoided. It is not possible for anyone who has not purchased the NFT and has not connected to the wallet to see the content.
Paper waste, fuel costs, unnecessary energy expenditures and unnecessary personnel costs will be prevented.
It will pave the way for easy and affordable access to works for everyone.
Although the exercise of certain rights and authorizations by publishing houses on behalf of author (academician, researcher, screenwriter, educator, poet, article writer-BRIEFLY AUTHOR) (likewise the protection of certain rights by publishing houses) is a facilitating process for author, it causes an increase in costs in the processes that bring author and reader together. The determinations regarding the costs are written below with a few basic data (transportation, shipping, time, personnel, labor, sales, damage to nature by wasting paper as a result of raw material supply of paper, i.e. trees etc.). Especially today and in the developing technological process, securing and tracking the work (periodicals, non-periodicals, books, etc.) will and have already become very easy with the digital coding and encryption method, thus gaining an ongoing and growing momentum. The fact that we have freed the author from the monopoly of the publishing house will also make it much easier for the work to reach the reader. The author shall determine the monetary value of his work. The author is currently dependent on the publisher. Eliminating this will make it much easier for information to reach those who demand it.
The development of technology, the concepts of web3, Industry 4.0 and the resulting information transformation trigger the rapid disappearance of physical materials.
This is also the only way forward for Sustainable Climate Peace and the world of tomorrow. In fact, with this technological facilitation, the author will be able to finalize the process in a digital environment without any problems related to secure copyright, which will also prevent paper waste. Meanwhile, we should increase energy production with renewable energy sources and thus, ensure the existence of the only power to run the technology, i.e. energy away from the destructive impact. The solution seems to be easier than the destruction of greenery and nature. One of our initiatives to support this transformation is to provide the energy source of the market and/or market (NFT MARKET) we will create from renewable energy.
Considering that it is a blockchain platform market where authors, owners of printed publications, publish their works, then anyone who enters the system can buy all the works, read and access them to the extent permitted by the author. However, due to the structure of the consensus, authors are allowed to add only their reviewed and controlled works to the system. The uniqueness of these works should be ensured by the publishing associations as part of the “consensus process”. In this case, it is in the interest of those who access this network to read the source, and in the interest of those who provide consensus to earn income by registering their works (copyright, etc.), and to reach a wider audience for a more affordable amount instead of the costly prices of publishing houses.
Let's say you own a digital work. You can give the key (password) of the work created by you to anyone you wish. You can encrypt it or not. The concepts of private key and public key are also important. Here, the digital asset encrypted with your private key can be made public with your public key (password). The private key remains accessible only for you. When a public key code is included in the transmission of a digital currency or other digital asset, the transmission is publicly visible. On the other side, you can access sharing with the key you have given that is compatible therewith. This process can be seen and audited by everyone. Thanks to hashing, by creating a private state, this Asset can be hidden from everyone else, encrypted and secured.
   So why should this Make Our Lives Easier?

The encryption mechanism ensures that all digital assets are securely transferred from one party to another without the need for any intermediary. We are talking about an outcome that eliminates decentralization.
For example, if there is a Blockchain platform where independent musicians publish their tracks, then anyone who enters the system can listen to and access all the music tracks. However, due to the consensus structure, only independent musicians are allowed to add tracks to the system. The originality and uniqueness of these tracks is ensured by the professional associations through a “consensus process”. In this case, it is possible that the interest of those who access this network is to listen to music, and the interest of those who provide consensus is to earn income by recording their works (royalties, etc.).

1. A system for publishing of the works (all kinds and types of digital or printed, audio books, scientific articles or papers, scripts, articles, peer-reviewed publications, magazines and journals of every kind, etc.), by means of Qualified Intellectual Property (QIP) and time stamp, by the author or title holder publishing house, uniquely in digital environment in the form of both first production and secondhand product and in any language whatsoever with the support of artificial intelligence, either by creating its own network or for running in polygon network or other networks (these networks indeed vary depending upon the licensing processes in blockchain and the working dynamics of each network, but polygon is only one of them and is exemplary), through working in more than one blockchain or via interchain passages, and with the support of smart contracts developed by Ethereum network (stands for internodal links and passages and for links in nodes), in line with the blockchain technology, as well as the duplication, promotion, distribution and sales services thereof, and again on QIP base, the promotion, marketing, distribution and sales of the works in metaverse (digital universe), and the detection and follow-up of infringements on copyrights with the help of algorithms, and the provision of such services to the author/publishing house in this aspect as well, and in these sales and/or promotion and marketing activities, for the sake of preservation of forest areas and nature with each transaction, and for follow-up of trees grown and contributions made to the nature, and for transparency therein, through registration of the same on blockchain, and timing thereof, and follow-up of its unchangeable and approved structure and process, and the distribution of token gifts again to authors or related interests through the market, and the distribution of various token as it is read or as the works are created, characterized in that it contains NFT whereby the work belonging to user is transformed with time stamp for operation in polygon network or other networks through supporting in more than one blockchain or in internodal passages supported by smart contracts developed by Ethereum network by means of Blockchain technology; and Barter-Sales Processes making it possible to buy an NFT work created by author and to resell the purchased work to a third party on second-hand basis; and Artificial Intelligence which facilitates the processes of author and/or users, and makes such processes easier, and develops alternatives depending on user habits, and also assures the tracking of pirated sale of works, and the tracking of unauthorized works in blockchain by means of algorithmic system, as a result of motivation, experience-algorithmic learning with the help of a software or computer program having a learning mechanism; and Token which ensures that prizes are given to users purchasing and reading the works, and barter price is paid out of prizes, and NFT creation costs are met; and Market Reports wherein artificial intelligence developer and publisher/author/writer can display the book marketing and sales rates and make a cost versus profit analysis; and Secondhand Sales whereby the purchaser of work can earn income also out secondhand sales when second-hand sales are effected in accordance with smart contract rules and second-hand sales profit rules as determined by the author; and Social Responsibility applications providing contributions by operating or forming compliant blockchain process or through different interchain passages for the same of contributions of the subject market to the nature; and digital market application which collects all applications included in digital market system under the roof of the same application and ensures that they are coordinated via the same application screen.

2. The system of claim 1, comprising a NFT application creating the capability of having fully decentralized and fully encrypted and unique digital books/works assets which are fully stored in blockchain and are comprised of digital or printed, audio books, scientific articles or papers, scripts, articles, peer-reviewed publications, magazines and journals, videos and songs, but also and works formed in NFT form, and smart contracts, and decentralized storage, and token using the blockchain infrastructure.

3. The system of claim 1, comprising a digital market application wherein users are enabled to sell their e-books or audio books in an open market, and to win tokens on the basis of progress recorded in reading/listening, or to share a digital book in the form of a physical book, and to buy a single composite audio book in more than one language, and to buy and sell their tokens for other crypto currencies in decentralized exchanges, and to provide the education system with a tool containing verified reading and continuous historical consumption records.

4. The system of claim 1, comprising a NFT application which allows publishers and writers to collect money through smart contracts in all types of sales, also including secondhand sales, thus providing them with a new income flow forever, and which assures security of management of digital rights, thus preventing digital frauds of any kind, and which also enables publishers to transfer their sales rights.

5. The system of claim 1, comprising a digital market application which is equipped with abilities of communication from writer to reader, and which enables the writers to produce unique collection digital editions of their books by means of publishers' marketing tools, as a brand new capability, and which brings e-books and audio books together, and allows them to be printed in such manner to be safely traceable, thus making it possible for independent writers to earn a higher income therefrom.

6. The system of claim 1, comprising a digital market application which allows NFT-based e-books at lower prices than open source Proof of Stake (POS) technology and Proof of Work (PoW) models, and offers different membership options for writers/publishers/readers, and includes different book and article publishing options and token gift options, and enables the user to have access to all processes with the lowest cost and in a cost-effective manner through NFT book transformation and sales commission options, and permits immediate access to and purchase of the work at any place in the world.

7. The system of claim 1, comprising a digital market application which assures security of user-author-publishing house and work through wallet binding option and other wallet options, and enables writer, publishing house and reader to create their own pages and interaction and community activities, and almost forms a platform for all digital evidences and acts as a notary public not only for books and printed matters, but also for copyright products intended to be protected, and provides international ownership and assurance, and whereby SPEED, TIME and SECURITY solutions are provided and scalability problem is overcome in an appropriate chain, and solutions are developed for registration of data pages, and facilitation of access of readers, and prevention of probable breaches by those who do not buy the same, and IDs are identified for publications and/or articles.

8. The system of claim 1, comprising a digital market application which includes NFT book pricing options (eth, usd, usdt, tl, try, matic, credit card and other coin and/or token options), as well as the book's index and/or summary sections on sales screen, and the writer's ID data, and the work's serial number as NFT ID uniquely, and wherein an option for tracking of unauthorized copies of the writer's work (algorithmic tracking, BREACH INQUIRY) is run, and is embedded in the system, and it is possible to pay transfer fees and book royalties in ecosystem to publishers, writers and Platform in the form of market token for the operating expenses.

9. The system of claim 1, comprising a social responsibility application wherein contribution to forests, green, nature and a sustainable world is stressed, and solutions are developed thereinfor, and which is integrated with blockchains.

10. The system of claim 1, comprising a Token application which is brought into force with writers/publishing houses and with platform (Blog)/drawing and gifts bringing the writers together, and which facilitates the winning of tokens produced by the market, and accepts Fiat currencies and crypto currencies as payment tools, and facilitates the purchasing of new books, given that the reading technology verifies which contents are read or listened by users within the frame of “reader mining” and “information mining”.

11. The system of claim 1, comprising a digital market application which is run by system open source codes making it possible to meet platform development and engineering costs, and is also operated in an integrated manner with different chains and side chains.

12. The system of claim 1, comprising a digital market application which allows the installation of stands, showrooms and exhibition grounds for works created by NFT in Metaverse universe, and permits immediate access thereto from any place in the world through internet relay chats and autograph session activities in digital environment.

13. The system of claim 1, wherein creation of a Work NFT Number comprises tracking pirated works through algorithmic systems, tracking unauthorized reproduced publications with artificial intelligence supported software, and detecting unauthorized copying using blockchain's unalterable and indelible distributed ledger technology.

14. A digital market system that enables the publication, copying, promotion, distribution and sale of works digitally with NFT and timestamp by using blockchain technology to be operated in multiple blockchains or in polygon network or other networks with cross-chain transitions or by creating its own network, wherein the system:
provides decentralized storage utilizing blockchain distributed ledger technology;
facilitates blockchain wallet integration for transaction processing;
enables NFT creation through smart contracts;
provides verification of ownership and authenticity through blockchain consensus mechanisms;
enables listing and purchasing of works; and
records ownership transfers through smart contracts in a blockchain.
